(19) United States
(12) Patent Application Publication
(10) Pub. No.: US 2011/0320195 A1
(43) Pub. Date: Dec. 29, 2011

(54) METHOD, APPARATUS AND SYSTEM FOR LINEAR PREDICTION CODING ANALYSIS

(76) Inventors: Jianfeng XU, Munich (DE); Lei Miao, Shenzhen (CN); Fengyan Ql, Beijing (CN); Dejun Zhang, Beijing (CN); Qing Zhang, Shenzhen (CN)

(21) Appl. No.: 13/228,965

(22) Filed: Sep. 9, 2011

Related U.S. Application Data
(63) Continuation of application No. PCT/CN2009/070729, filed on Mar. 11, 2009.

(51) Int. Cl. G10L 19/00

(52) U.S. Cl. 704/219; 704/E19.001

(57) ABSTRACT

The present invention relates to communication technologies and discloses a method, an apparatus and a system for Linear Prediction Coding (LPC) analysis to improve LPC prediction performance and simplify analysis operation. The method includes: obtaining signal feature information of at least one sample point of input signals; comparing and analyzing the signal feature information to obtain an analysis result; selecting a window function according to the analysis result to perform adaptive windowing for the input signals and obtain windowed signals; and processing the windowed signals to obtain an LPC coefficient for linear prediction. The embodiments of the present invention are applicable to LPC.

### CROSS-REFERENCE TO RELATED APPLICATIONS

This application is a continuation of International Application No. PCT/CN2009/070729, filed on Mar. 11, 2009, which is hereby incorporated by reference in its entirety.

### FIELD OF THE INVENTION

The present invention relates to communication technologies, and in particular, to a method, an apparatus, and a system for Linear Prediction Coding (LPC) analysis.

### BACKGROUND OF THE INVENTION

In order to save bandwidth for transmitting and storing voice and audio signals, voice and audio coding technologies are applied widely, for example, lossy coding and lossless coding. In the lossy coding, the reconstructed signals are not completely the same as the original signals, but redundant information of signals may be minimized according to the sound source features and the human perception features. In the lossless coding, the reconstructed signals need to be completely the same as the original signals so that the final decoding quality is not impaired at all. Generally, in the lossy coding, the compression ratio is high, but the quality of the reconstructed voice may not be ensured; in the lossless coding, the voice quality is ensured, but the compression ratio is as low as about 50%.

In both the lossy coding and the lossless coding, an LPC (Linear Prediction Coding) model is widely applied to voice coding. In the lossy coding, a typical application of the LPC model is Code Excited Linear Prediction (CELP) coding model. The fundamentals of the CELP coding model are: remove the near sample point redundancy of voice signals by using short-time linear prediction, remove the far sample point redundancy of voice signals by using a long-time predictor, and perform coded transmission for parameters generated in the prediction process and residual signals obtained through the two levels of prediction.

Currently, the LPC analysis of lossy and lossless audio coding/decoding generally involves three modules: windowing module auto-correlation module, and Levinson algorithm module. Residual signals are obtained through linear prediction, and are coded through entropy coding to implement audio compression.

In the process of LPC, the prior art at least exists the following problems:

A fixed window function is applied in the windowing process, which makes the linear prediction performance not optimal.

Alternatively, the input signals undergo two rounds of LPC analysis; in the first round of LPC analysis, a short window is applied to the signals; in the second round of LPC analysis, a long window is applied to the signals, which increases complexity of the LPC analysis.

### SUMMARY OF THE INVENTION

The embodiments of the present invention provide a method, an apparatus and a system for LPC analysis to improve linear prediction performance and simplify analysis operation.

An LPC analysis method includes:

obtaining signal feature information of at least one sample point of input signals;

comparing and analyzing the signal feature information to obtain an analysis result; and

selecting a window function according to the analysis result to perform adaptive windowing for the input signals and obtain windowed signals; and

processing the windowed signals to obtain an LPC coefficient for linear prediction.

Through the LPC analysis method provided in the present invention, the input signals are analyzed to obtain an analysis result, and a window function required for windowing is allocated adaptively according to the analysis result. In this way, the prediction performance of LPC is improved with little increased complexity of coding.

An LPC analysis apparatus includes:

an obtaining unit, configured to obtain signal feature information of at least one sample point of input signals;

an analyzing unit, configured to compare and analyze the signal feature information to obtain an analysis result;

a windowing unit, configured to select a window function according to the analysis result to perform adaptive windowing for the input signals and obtain windowed signals; and

a processing unit, configured to process the windowed signals to obtain an LPC coefficient for linear prediction.

The LPC analysis apparatus provided in embodiments of the present invention are configured to analyze the input signals to obtain an analysis result, and allocate adaptively a window function required for windowing according to the analysis result. In this way, the prediction performance of LPC is improved with little increased complexity of coding.

An LPC system includes:

an LPC analysis apparatus, configured to: obtain signal feature information of at least one sample point of input signals; compare and analyze the signal feature information to obtain an analysis result; select a window function according to the analysis result to perform adaptive windowing for the input signals and obtain windowed signals; and process the windowed signals to obtain an LPC coefficient; and

a coding apparatus, configured to perform coding according to the LPC coefficient obtained by the LPC analysis apparatus.

Through the LPC system provided in embodiments of the present invention, the input signals are analyzed to obtain an analysis result, and a window function required for windowing is allocated adaptively according to the analysis result to obtain an LPC coefficient, and then coding is performed according to the LPC coefficient. In this way, the prediction performance of LPC is improved with little increased complexity of coding.

### BRIEF DESCRIPTION OF THE DRAWINGS

To make embodiments of the present invention or technical solutions in the prior art clearer, the following outlines the accompanying drawings involved in the embodiments of the present invention or the prior art. Apparently, the accompanying drawings outlined below are illustrative rather than exhaustive, and persons of ordinary skill in the art can derive other drawings from them without any creative effort.

FIG. 1 is a block flowchart of an LPC analysis method according to an embodiment of the present invention;

FIG. 2 is a block flowchart of an LPC analysis method according to a first embodiment of the present invention;

FIG. 3 is a block flowchart of an LPC analysis method according to a second embodiment of the present invention;

FIG. 4 is a block flowchart of an LPC analysis method according to a third embodiment of the present invention;

FIG. 5 is a block flowchart of an LPC analysis method according to a fourth embodiment of the present invention;

FIG. 6 is a block flowchart of an LPC analysis method according to a fifth embodiment of the present invention;

FIG. 7 is a block flowchart of an LPC analysis method according to a sixth embodiment of the present invention;

FIG. 8 is a block flowchart of an LPC analysis method according to a seventh embodiment of the present invention;

FIG. 9 is a structure block diagram of an LPC analysis apparatus according to an embodiment of the present invention;

FIG. 10 is a structure block diagram of an LPC analysis apparatus according to another embodiment of the present invention;

FIG. 11 is a structure block diagram of an LPC system according to an embodiment of the present invention; and

FIG. 12 is a structure block diagram of an LPC system according to another embodiment of the present invention.

### DETAILED DESCRIPTION OF THE EMBODIMENTS

The following detailed description is given in conjunction with the accompanying drawings to provide a thorough understanding of the present invention. Evidently, the described embodiments are merely part of rather than all embodiments. All other embodiments, which can be derived by those skilled in the art from the embodiments given herein without any creative effort, shall fall within the scope of the present invention.

The embodiments of the present invention provide a method, an apparatus and a system for LPC analysis to improve linear prediction performance and simplify analysis operation.

The embodiments of the present invention are described in detail below with reference to accompanying drawings.

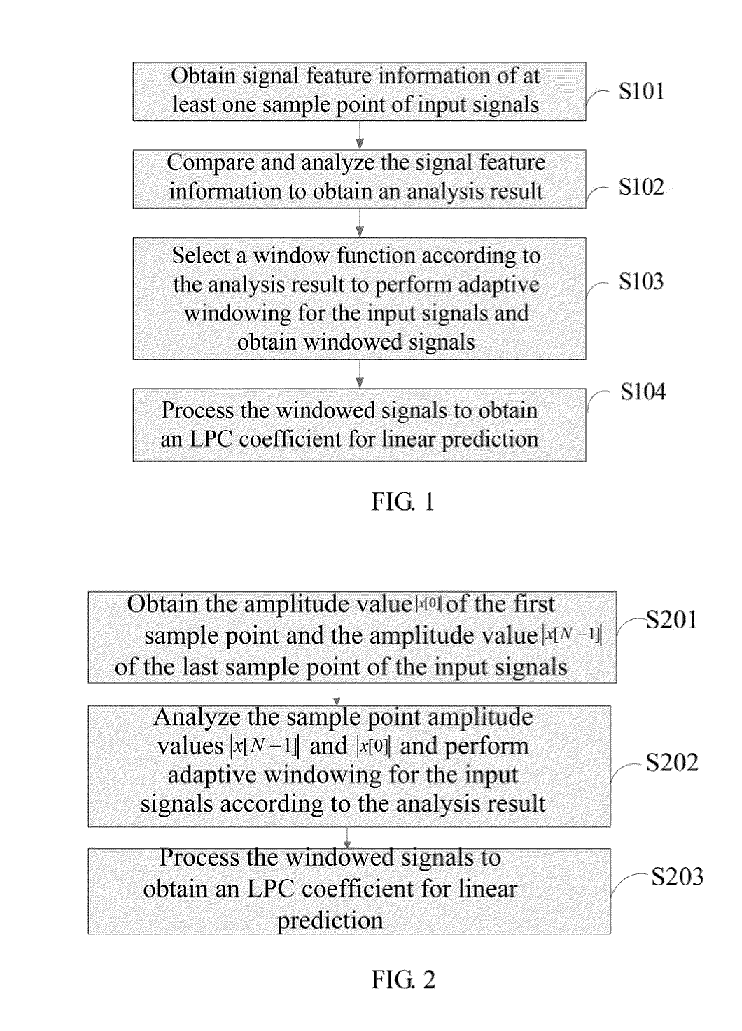

As shown in FIG. 1, an LPC analysis method provided in an embodiment of the present invention includes the following steps:

S101. Obtain signal feature information of at least one sample point of input signals.

S102. Compare and analyze the signal feature information to obtain an analysis result.

S103. Select a window function according to the analysis result to perform adaptive windowing for the input signals and obtain windowed signals.

S104. Process the windowed signals to obtain an LPC coefficient for linear prediction.

Through the LPC analysis method provided herein, the input signals are analyzed to obtain an analysis result, and a window function required for windowing is allocated adaptively according to the analysis result. In this way, the prediction performance of LPC is improved with little increased complexity of coding.

The information feature information includes any one or any combination of amplitude, energy, zero-crossing rate, signal type, frame length, coding mode.

The method is described with the following embodiments of the present invention.

### Embodiment 1

As shown in FIG. 2, an LPC analysis method provided in the first embodiment of the present invention includes the following steps:

S201. Obtain an amplitude value |x[0]| of a first sample point and an amplitude value |x[N−1]| of a last sample point of input signals, where x[i], i=0, 1, . . . , N−1 are input signals, N is the number (such as 40, 80, 160, 240, or 320) of sample points of the input signals. The input signals herein refer to signals input for LPC analysis, and may be a frame of signals, or may be a frame of signals plus a segment of signals in a history buffer (such as L sample points in the history buffer, where L is a positive integer such as 40, 80, 160, 240, or 320, according to the type of codec).

S202. Analyze amplitude values |x[0]| and |x[N−1]| of the sample point and perform adaptive windowing for the input signals according to the analysis result.

For example, when the number of sample points of the input signals is 40:

If the amplitude value |x[0]| of the first sample point of the input signals is less than a preset threshold thr (such as thr=128), the first 4 points of the window function are set as:

w(n)=0.23+0.77·cos(2·π·(31−8·n)/127), n=0, 1, 2, 3.

Otherwise, the first 4 points of the window function are set as:

w(n)=0.26+0.74·cos(2·π·(31−8·n)/127), n=0, 1, 2, 3.

Points 5-36 of the window function are set to 1s, namely,

w(n)=1, n=4, . . . , 35.

If the amplitude value |x[39]| of the last sample point of the input signals is less than a preset threshold thr (such as thr=128), the last 4 points of the window function are set as:

w(n)=0.23+0.77·cos(2·π·(8·n−281)/127), n=36, 37, 38, 39.

Otherwise, the last 4 points of the window function are set as:

w(n)=0.26+0.74·cos(2·π·(8·n−281)/127), n=36, 37, 38, 39.

Afterward, signals x(n), n=1, 2, . . . , 38, 39 are windowed by using the adaptively set window function w(n), n=1, 2, . . . , 38, 39, namely,

xd[n]=x[n]·w[n], n=0, 1, . . . , 38, 39.

As a result, the adaptively windowed signals xd[n]], n=0, 1, . . . , 38, 39 are obtained.

In another example, when the number of sample points of the input signals is 80:

If the amplitude value |x[0]| of the first sample point of the input signals is less than a preset threshold thr (such as thr−128) the first 8 points of the window function are set as:

w(n)=0.26+0.74·cos(2·π·(31−4·n)/127), n=0, 1, 2, . . . , 7.

Otherwise, the first 8 points of the window function are set as:

w(n)=0.16+0.84·cos(2·π·(31−4·n)/127), n=0, 1, 2, . . . , 7.

Points 9-72 of the window function are set to 1s, namely,

w(n)=1, n=8, . . . , 71.

If the amplitude value |x[79]| of the last sample point of the input signals is less than a preset threshold thr (such as thr=128) the last 8 points of the window function are set as:

w(n)=0.26+0.74·cos(2·π·(4·n−285)/127), n=72, 73, 74, . . . , 79.

Otherwise, the last 8 points of the window function are set as:

w(n)=0.16+0.84·cos(2·π·(4·n−285)/127), n=72, 73, 74, . . . , 79.

Afterward, signals x(n), n=0, 1, . . . , 78, 79 are windowed by using the adaptively set window function w(n), n=0, 1, . . . , 78, 79, namely,

xd[n]=x[n]·w[n], n=0, 1, . . . , 78, 79.

As a result, the adaptively windowed signals xd[n]], n=0, 1, . . . , 78, 79 are obtained.

The policy of adjusting the window function w[n] is selected through plenty of experiments according to the type of vocoder.

The threshold thr is also selected through plenty of experiments, for example, thr=128 or thr=157

S203. Process the windowed signals to obtain an LPC coefficient for linear prediction.

Through the LPC analysis method provided in the first embodiment, the amplitude values of the first sample point and the last sample point of the input signals are obtained, and the input signals are windowed adaptively according to the amplitude values of sample points. In this way, the prediction performance of LPC is improved with little increased complexity of coding.

### Embodiment 2

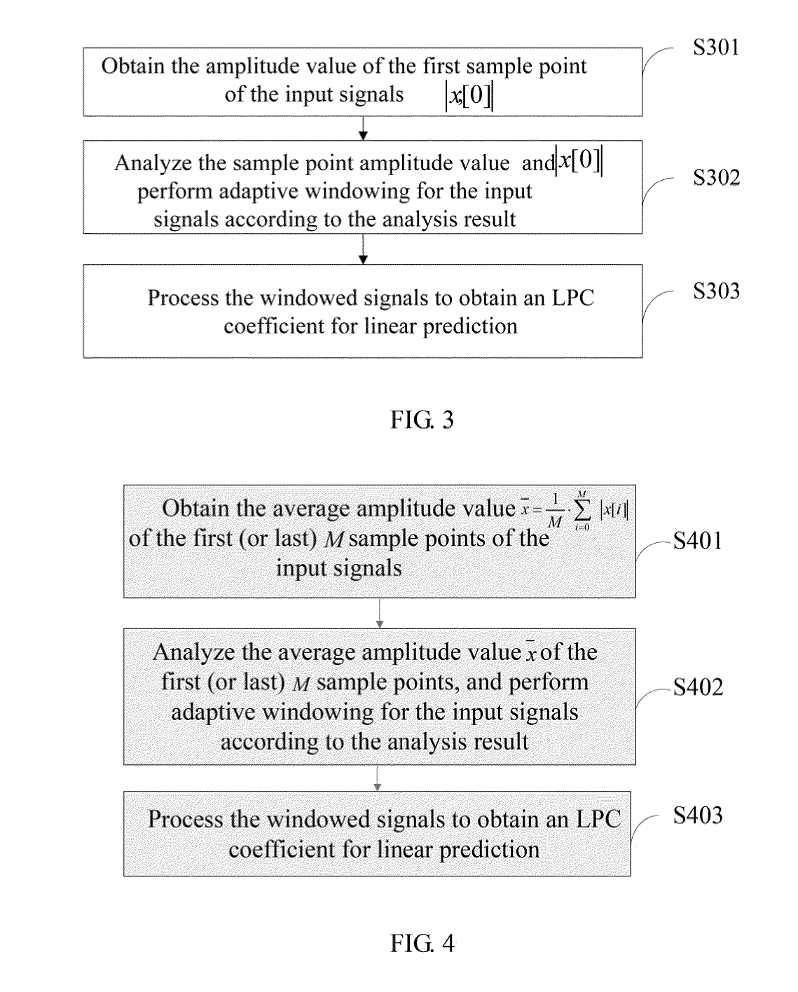

As shown in FIG. 3, an LPC analysis method provided in the second embodiment of the present invention includes the following steps:

S301. Obtain an amplitude value |x[0]| of a first sample point of input signals, where x[i], i=0, 1, . . . , N−1 refers to input signals, and N is the number of sample points of the input signals. The input signals herein refer to signals input for LPC analysis, and may be a frame of signals, or may be a frame of signals plus a segment of signals in a history buffer (such as L sample points in the history buffer, where L is a positive integer, such as 40 or 80, and value of L varies with the type of the codec).

S302. Analyze amplitude value |x[0]| of the sample point and perform adaptive windowing for the input signals according to the analysis result.

If the amplitude value |x[0]| of the first sample point of the input signals is greater than or equal to a preset threshold thr, the input signals are windowed by using the first window function, namely, by letting xd[i] be x[i] ·w1[i], i=0, 1, . . . , N−1, where xd[i] refers to windowed signals and w1[i] is the first window function.

Otherwise, the input signals are windowed by using the second window function, namely, by letting xd[i] be x[i]·w2[i]=0, 1, . . . , N−1, where w2[i] is the second window function.

The window function w1[i] and the window function w2[i] may be selected through plenty of experiments according to the type of vocoder, and are applicable to different signals. For example, w1[i] is a sine window and w2[i] is a Hamming window; or, w1[i] is a Hamming window and w2[i] is a sine window. The threshold thr may also be selected through plenty of experiments, for example, thr=128 or thr=157.

In an instance, thr=128; and, when the frame length N=80,

$$w 1 [ i ] = \{ \begin{matrix}0.16 + 0.84 \cdot cos ( 2 \cdot π \cdot ( 31 - 4 \cdot i ) / 127 ) , & i = 0 , 1 , … , 7 \\ 1 , & i = 8 , 9 , … , 71 \\ 0.16 + 0.84 \cdot cos ( 2 \cdot π \cdot ( 4 \cdot i - 285 ) / 127 ) , & i = 72 , 73 , … , 79\end{matrix} \\ w 2 [ i ] = \{ \begin{matrix}0.26 + 0.74 \cdot cos ( 2 \cdot π \cdot ( 31 - 4 \cdot i ) / 127 ) , & i = 0 , 1 , … , 7 \\ 1 , & i = 8 , 9 , … , 71 \\ 0.26 + 0.74 \cdot cos ( 2 \cdot π \cdot ( 4 \cdot i - 285 ) / 127 ) , & i = 72 , 73 , … , 79.\end{matrix}$$

When the frame length N=40,

$$w 1 [ i ] = \{ \begin{matrix}0.26 + 0.74 \cdot cos ( 2 \cdot π \cdot ( 31 - 8 \cdot i ) / 127 ) , & i = 0 , 1 , … , 3 \\ 1 , & i = 4 , 5 , … , 35 \\ 0.26 + 0.74 \cdot cos ( 2 \cdot π \cdot ( 8 \cdot i - 281 ) / 127 ) , & i = 36 , 37 , … , 39\end{matrix} \\ w 1 [ i ] = \{ \begin{matrix}0.23 + 0.77 \cdot cos ( 2 \cdot π \cdot ( 31 - 8 \cdot i ) / 127 ) , & i = 0 , 1 , … , 3 \\ 1 , & i = 4 , 5 , … , 35 \\ 0.23 + 0.77 \cdot cos ( 2 \cdot π \cdot ( 8 \cdot i - 281 ) / 127 ) , & i = 36 , 37 , … , 39.\end{matrix}$$

S303. Process the windowed signals to obtain an LPC coefficient for linear prediction.

Through the LPC analysis method provided in the second embodiment, the amplitude value of the first sample point of the input signals is obtained, and the input signals are windowed adaptively according to the amplitude value of the sample point. In this way, the prediction performance of LPC is improved with little increased complexity of coding.

### Embodiment 3

As shown in FIG. 4, an LPC analysis method provided in the third embodiment of the present invention includes the following steps:

S401. Obtain an average amplitude value

$$\overline{x} = \frac{1}{M} \cdot {\sum }_{i 0}^{M} \vert x [ i ] \vert$$

of the first (or last) M sample points of input signals, where x[i], i=0, 1, . . . , N−1 refers to input signals, and N is the number of sample points of the input signals. The input signals herein refer to signals input for LPC analysis, and may be a frame of signals, or may be a frame of signals plus a segment of signals in a history buffer (such as L sample points in the history buffer, where L is a positive integer, such as 40 or 80, and value of L varies with the type of the codec).

S402. Analyze the average amplitude value x̅ of the first (or last) M sample points, and perform adaptive windowing for the input signals according to the analysis result.

If the average amplitude value x̅ of the first (or last) M sample points is greater than or equal to a preset threshold thr, the input signals are windowed by using the first window function, namely, by letting xd[i] be x[i]·w1[i], i=0, 1, . . . , N−1, where xd[i] refers to windowed signals and w1[i] is the first window function.

Otherwise, the input signals are windowed by using the second window function, namely, by letting xd[i] be x[i]·w2[i], i=0, 1, . . . , N−1, where w2[i] is the second window function.

The window function w1[i] and the window function w2[i] may be selected through plenty of experiments according to the type of vocoder, and are applicable to different signals. For example, w1[i] is a sine window and w2[i] is a Hamming window; or, w1[i] is a Hamming window and w2[i] is a sine window. The threshold thr may also be selected through plenty of experiments, for example, thr=127 or thr=152.

In an instance, thr=128; and, when the frame length N=80,

$$w 1 [ i ] = \{ \begin{matrix}0.15 + 0.85 \cdot cos ( 2 \cdot π \cdot ( 31 - 4 \cdot i ) / 127 ) , & i = 0 , 1 , … , 7 \\ 1 , & i = 8 , 9 , … , 7 \; 1 \\ 0.15 + 0.85 \cdot cos ( 2 \cdot π \cdot ( 4 \cdot i - 285 ) / 127 ) , & i = 72 , 73 , … , 79\end{matrix} \\ w 2 [ i ] = \{ \begin{matrix}0.27 + 0.73 \cdot cos ( 2 \cdot π \cdot ( 31 - 4 \cdot i ) / 127 ) , & i = 0 , 1 , … , 7 \\ 1 , & i = 8 , 9 , … , 7 \; 1 \\ 0.27 + 0.73 \cdot cos ( 2 \cdot π \cdot ( 4 \cdot i - 285 ) / 127 ) , & i = 72 , 73 , … , 79.\end{matrix}$$

When the frame length N=40,

$$w 1 [ i ] = \{ \begin{matrix}0.26 + 0.74 \cdot cos ( 2 \cdot π \cdot ( 31 - 8 \cdot i ) / 127 ) , & i = 0 , 1 , … , 3 \\ 1 , & i = 4 , 5 , … , 35 \\ 0.26 + 0.74 \cdot cos ( 2 \cdot π \cdot ( 8 \cdot i - 281 ) / 127 ) , & i = 36 , 37 , … , 39\end{matrix} \\ w 1 [ i ] = \{ \begin{matrix}0.23 + 0.77 \cdot cos ( 2 \cdot π \cdot ( 31 - 8 \cdot i ) / 127 ) , & i = 0 , 1 , … , 3 \\ 1 , & i = 4 , 5 , … , 35 \\ 0.23 + 0.77 \cdot cos ( 2 \cdot π \cdot ( 8 \cdot i - 281 ) / 127 ) , & i = 36 , 37 , … , 39.\end{matrix}$$

S403. Process the windowed signals to obtain an LPC coefficient for linear prediction.

Through the LPC analysis method provided in the third embodiment, the average amplitude value of the first (or last) M sample points of the input signals is obtained, and the input signals are windowed adaptively according to the average amplitude value. In this way, the prediction performance of LPC is improved with little increased complexity of coding.

### Embodiment 4

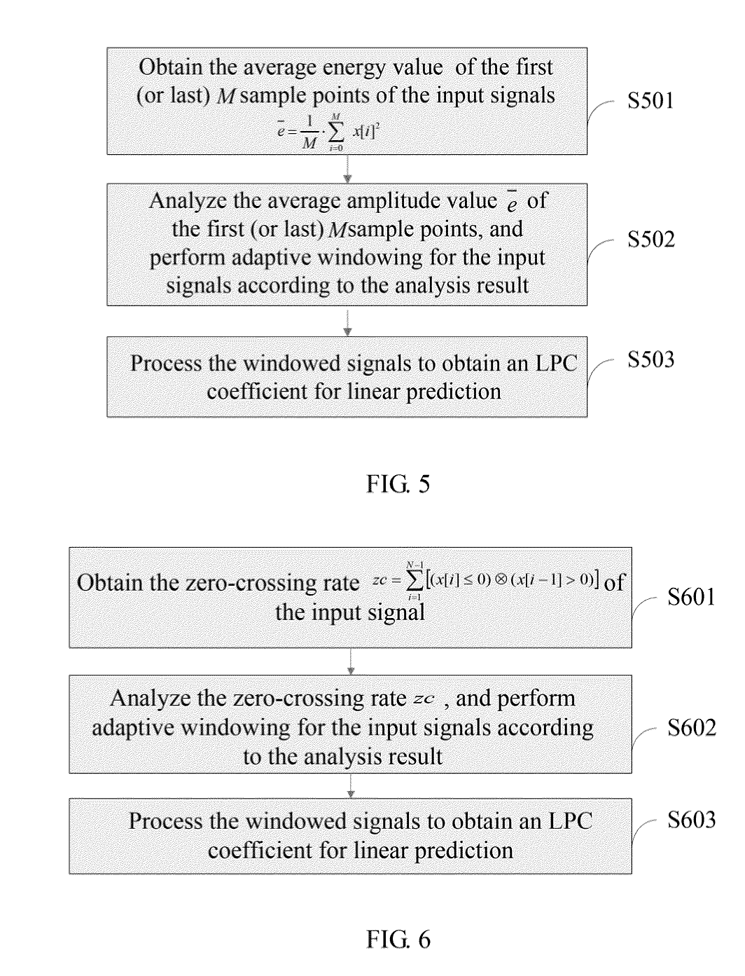

As shown in FIG. 5, an LPC analysis method provided in the fourth embodiment of the present invention includes the following steps:

S501. Obtain an average energy value

$$\overline{e} = \frac{1}{M} \cdot {\sum }_{i = 0}^{M} {x [ i ]}^{2}$$

of the first (or last) M sample points of input signals, where x[i], i=0, 1, . . . , N−1 refers to the input signals, and N is the number of sample points of the input signals.

The input signals herein refer to signals input for LPC analysis, and may be a frame of signals, or may be a frame of signals plus a segment of signals in a history buffer (such as L sample points in the history buffer, where L is a positive integer, such as 40 or 80, and value of L varies with the type of the codec).

S502. Analyze the average energy value ē of the first (or last) M sample points, and perform adaptive windowing for the input signals according to the analysis result.

If the average energy value ē of the first (or last) M sample points is greater than or equal to a preset threshold thr, the input signals are windowed by using the first window function, namely, by letting xd[i] be x[i]·w1[i], i=0, 1, . . . , N−1, where xd[i] refers to windowed signals and w1[i] is the first window function.

Otherwise, the input signals are windowed by using the second window function, namely, by letting xd[i] be x[i]·w2[i], i=0, 1, . . . , N−1, where w2[i] is the second window function.

The window function w1[i] and the window function w2[i] may be selected through plenty of experiments according to the type of vocoder, and are applicable to different signals. For example, w1[i] is a sine window and w2[i] is a Hamming window; or, w1[i] is a Hamming window and w2[i] is a sine window. The threshold thr may also be selected through plenty of experiments, for example, thr=1024 or thr=2573.

In an instance, thr=1280; and, when the frame length N=80,

$$w 1 [ i ] = \{ \begin{matrix}0.18 + 0.82 \cdot cos ( 2 \cdot π \cdot ( 31 - 4 \cdot i ) / 127 ) , & i = 0 , 1 , … , 7 \\ 1 , & i = 8 , 9 , … , 71 \\ 0.18 + 0.82 \cdot cos ( 2 \cdot π \cdot ( 4 \cdot i - 285 ) / 127 ) , & i = 72 , 73 , … , 79\end{matrix} \\ w 2 [ i ] = \{ \begin{matrix}0.25 + 0.75 \cdot cos ( 2 \cdot π \cdot ( 31 - 8 \cdot i ) / 127 ) , & i = 0 , 1 , … , 7 \\ 1 , & i = 8 , 9 , … , 71 \\ 0.25 + 0.75 \cdot cos ( 2 \cdot π \cdot ( 4 \cdot i - 285 ) / 127 ) , & i = 72 , 73 , … , 79.\end{matrix}$$

When the frame length N=40,

$$w 1 [ i ] = \{ \begin{matrix}0.25 + 0.75 \cdot cos ( 2 \cdot π \cdot ( 31 - 8 \cdot i ) / 127 ) , & i = 0 , 1 , … , 3 \\ 1 , & i = 4 , 5 , … , 35 \\ 0.25 + 0.75 \cdot cos ( 2 \cdot π \cdot ( 8 \cdot i - 281 ) / 127 ) , & i = 36 , 37 , … , 39\end{matrix} \\ w 1 [ i ] = \{ \begin{matrix}0.24 + 0.76 \cdot cos ( 2 \cdot π \cdot ( 31 - 8 \cdot i ) / 127 ) , & i = 0 , 1 , … , 3 \\ 1 , & i = 4 , 5 , … , 35 \\ 0.24 + 0.76 \cdot cos ( 2 \cdot π \cdot ( 8 \cdot i - 281 ) / 127 ) , & i = 36 , 37 , … , 39.\end{matrix}$$

S503. Process the windowed signals to obtain an LPC coefficient for linear prediction.

Through the LPC analysis method provided in the fourth embodiment, the average energy value of the first (or last) M sample points of the input signals is obtained, and the input signals are windowed adaptively according to the average energy value. In this way, the prediction performance of LPC is improved with little increased complexity of coding.

### Embodiment 5

As shown in FIG. 6, an LPC analysis method provided in the fifth embodiment of the present invention includes the following steps:

S601. Obtain a zero-crossing rate

$$zc = {\sum }_{i = 1}^{N - 1} [ ( x [ i ] \leq 0 ) ⊗ ( x [ i - 1 ] > 0 ) ]$$

of the input signals, where x[i], i=0, 1, . . . , N−1 refers to the input signals, N is the number of sample points of the input signals, and [symbol] refers to AND operation.

The input signals herein refer to signals input for LPC analysis, and may be a frame of signals, or may be a frame of signals plus a segment of signals in a history buffer (such as L sample points in the history buffer, where L is a positive integer, such as 40 or 80, and value of L varies with the type of the codec).

S602. Analyze the zero-crossing rate zc, and perform adaptive windowing for the input signals according to the analysis result.

If the zero-crossing rate zc is greater than or equal to a preset threshold thr, the input signals are windowed by using the first window function, namely, by letting xd[i] be xd[i]=x[i]·w1[i] i=0, 1, . . . , N−1, where xd[i] refers to windowed signals and w1[i] is the first window function.

Otherwise, the input signals are windowed by using the second window function, namely, by letting xd[i] be xd[i]=x[i]·w2[i], i=0, 1, . . . , N−1, where w2[i] is the second window function.

The window function w[i] and the window function w2[i] may be selected through plenty of experiments according to the type of vocoder, and are applicable to different signals. For example, w1[i] is a sine window and w2[i] is a Hamming window; or, w1[i] is a Hamming window and w2[i] is a sine window.

The threshold thr may also be selected through plenty of experiments, for example, thr=15 or thr=23 .

In an instance, thr=18; and, when the frame length N=80,

$$w 1 [ i ] = \{ \begin{matrix}0.16 + 0.84 \cdot cos ( 2 \cdot π \cdot ( 31 - 4 \cdot i ) / 127 ) , & i = 0 , 1 , … , 7 \\ 1 , & i = 8 , 9 , … , 71 \\ 0.16 + 0.84 \cdot cos ( 2 \cdot π \cdot ( 4 \cdot i - 285 ) / 127 ) , & i = 72 , 73 , … , 79\end{matrix} \\ w 2 [ i ] = \{ \begin{matrix}0.26 + 0.74 \cdot cos ( 2 \cdot π \cdot ( 31 - 4 \cdot i ) / 127 ) , & i = 0 , 1 , … , 7 \\ 1 , & i = 8 , 9 , … , 71 \\ 0.26 + 0.74 \cdot cos ( 2 \cdot π \cdot ( 4 \cdot i - 285 ) / 127 ) , & i = 72 , 73 , … , 79.\end{matrix}$$

When the frame length N=40,

$$w 1 [ i ] = \{ \begin{matrix}0.27 + 0.73 \cdot cos ( 2 \cdot π \cdot ( 31 - 8 \cdot i ) / 127 ) , & i = 0 , 1 , … , 3 \\ 1 , & i = 4 , 5 , … , 35 \\ 0.27 + 0.73 \cdot cos ( 2 \cdot π \cdot ( 8 \cdot i - 281 ) / 127 ) , & i = 36 , 37 , … , 39\end{matrix} \\ w 1 [ i ] = \{ \begin{matrix}0.25 + 0.75 \cdot cos ( 2 \cdot π \cdot ( 31 - 8 \cdot i ) / 127 ) , & i = 0 , 1 , … , 3 \\ 1 , & i = 4 , 5 , … , 35 \\ 0.25 + 0.75 \cdot cos ( 2 \cdot π \cdot ( 8 \cdot i - 281 ) / 127 ) , & i = 36 , 37 , … , 39.\end{matrix}$$

S603. Process the windowed signals to obtain an LPC coefficient for linear prediction.

Through the LPC analysis method provided in the fifth embodiment, the zero-crossing rate of the input signals is obtained, and the input signals are windowed adaptively according to the zero-crossing rate. In this way, the prediction performance of LPC is improved with little increased complexity of coding.

### Embodiment 6

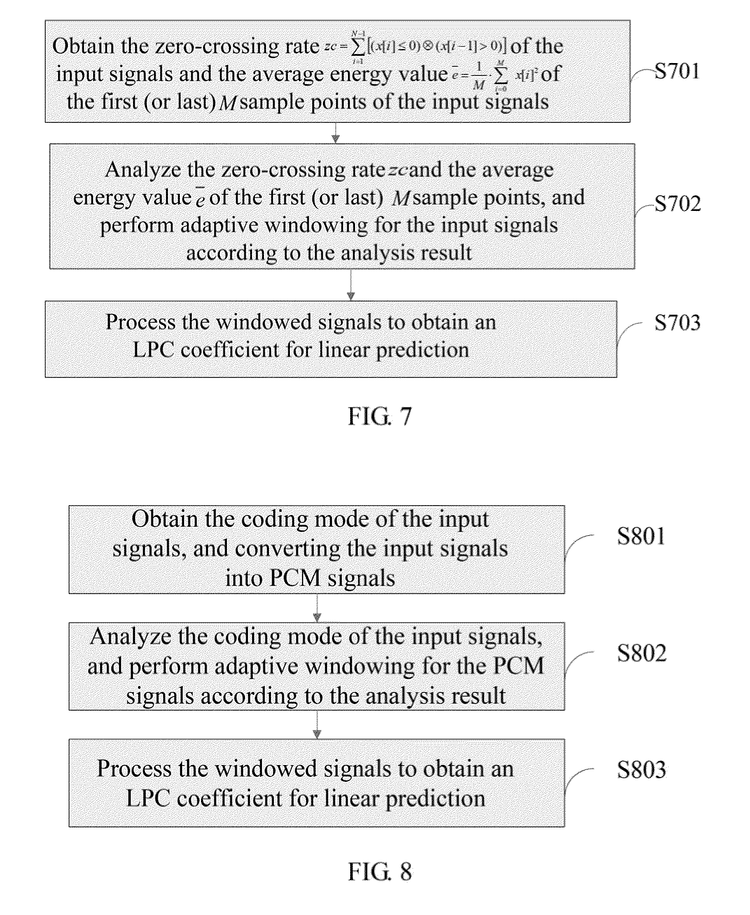

As shown in FIG. 7, an LPC analysis method provided in the sixth embodiment of the present invention includes the following steps:

S701. Obtain a zero-crossing rate

$$zc = {\sum }_{i 1}^{N - 1} [ ( x [ i ] < 0 ) ⊗ ( x [ i - 1 ] > 0 ) ]$$

of input signals and an average energy value

$$\overline{e} = \frac{1}{M} \cdot {\sum }_{i = 0}^{M} {x [ i ]}^{2}$$

of the first (or last) M sample points, where x[i], i=0, 1, . . . , N−1 refers to the input signals, N is the number of sample points of the input signals, and [symbol] refers to AND operation. The input signals herein refer to signals input for LPC analysis, and may be a frame of signals, or may be a frame of signals plus a segment of signals in a history buffer (such as L sample points in the history buffer, where L is a positive integer, such as 40 or 80, and value of L varies with the type of the codec).

S702. Analyze the zero-crossing rate zc and the average energy value ē of the first (or last) M sample points, and perform adaptive windowing for the input signals according to the analysis result.

If the zero-crossing rate zc is greater than or equal to a preset threshold thr1, or, if ē is less than or equal to a preset threshold thr2, the input signals are windowed by using the first window function, namely, by letting xd[i] be x[i]·w1[i], i=0, 1, . . . , N−1, where xd[i] refers to windowed signals and w1[i] is the first window function.

Otherwise, the input signals are windowed by using the second window function, namely, by letting xd[i] be x[i]·w2[i], i=0, 1, . . . , N−1, where w2[i] is the second window function.

The window function w[i] and the window function w2[i] may be selected through plenty of experiments according to the type of vocoder, and are applicable to different signals. For example, w[i] is a sine window and w2[i] is a Hamming window; or, w1[i] is a Hamming window and w2[i] is a sine window. The threshold thr1 and the threshold thr2 may also be selected through plenty of experiments, for example, thr1=15 and thr2=1023; or thr1=23 and thr2=1012.

In an instance, thr1=17 and thr2=1012; and, when the frame length N=80,

$$w 1 [ i ] = \{ \begin{matrix}0.16 + 0.84 \cdot cos ( 2 \cdot π \cdot ( 31 - 4 \cdot i ) / 127 ) , & i = 0 , 1 , … , 7 \\ 1 , & i = 8 , 9 , … , 71 \\ 0.16 + 0.84 \cdot cos ( 2 \cdot π \cdot ( 4 \cdot i - 285 ) / 127 ) , & i = 72 , 73 , … , 79\end{matrix} \\ w 2 [ i ] = \{ \begin{matrix}0.26 + 0.74 \cdot cos ( 2 \cdot π \cdot ( 31 - 4 \cdot i ) / 127 ) , & i = 0 , 1 , … , 7 \\ 1 , & i = 8 , 9 , … , 71 \\ 0.26 + 0.74 \cdot cos ( 2 \cdot π \cdot ( 4 \cdot i - 285 ) / 127 ) , & i = 72 , 73 , … , 79.\end{matrix}$$

When the frame length N=40,

$$w 1 [ i ] = \{ \begin{matrix}0.28 + 0.72 \cdot cos ( 2 \cdot π \cdot ( 31 - 8 \cdot i ) / 127 ) , & i = 0 , 1 , … , 3 \\ 1 , & i = 4 , 5 , … , 35 \\ 0.28 + 0.72 \cdot cos ( 2 \cdot π \cdot ( 8 \cdot i - 281 ) / 127 ) , & i = 36 , 37 , … , 39\end{matrix} \\ w 1 [ i ] = \{ \begin{matrix}0.22 + 0.78 \cdot cos ( 2 \cdot π \cdot ( 31 - 8 \cdot i ) / 127 ) , & i = 0 , 1 , … , 3 \\ 1 , & i = 4 , 5 , … , 35 \\ 0.22 + 0.78 \cdot cos ( 2 \cdot π \cdot ( 8 \cdot i - 281 ) / 127 ) , & i - 36 , 37 , … , 39.\end{matrix}$$

S703. Process the windowed signals to obtain an LPC coefficient for linear prediction.

Through the LPC analysis method provided in the sixth embodiment, the zero-crossing rate of the input signals and the average energy value of the first (or last) M sample points of the input signals are obtained, and the input signals are windowed adaptively according to the zero-crossing rate and the average energy value. In this way, the prediction performance of LPC is improved with little increased complexity of coding.

### Embodiment 7

As shown in FIG. 8, an LPC analysis method provided in the seventh embodiment of the present invention includes the following steps:

S801. Obtain the coding mode of input signals, and convert the input signals into Pulse Coding Modulation (PCM) signals, where the input signals are G.711 signals, and the input signals may be A-law signals or mu-law signals.

S802. Analyze the coding mode of the input signals, and perform adaptive windowing for the PCM signals according to the analysis result.

If the coding mode is A-law, the PCM signals are windowed by using the first window function, namely, by letting xd[i] be x[i]·w1[i], i=0, 1, . . . , N−1, where xd[i] refers to windowed signals, w1[i] is the first window function, and x[i] refers to PCM signals.

Otherwise, the PCM signals are windowed by using the second window function, namely, by letting xd[i] be x[i]·w2[i], i=0, 1, . . . , N−1, where w2[i] is the second window function.

The window function w1[i] and the window function w2[i] may be selected through plenty of experiments according to the type of vocoder, and are applicable to different signals. For example, w1[i] is a sine window and w2[i] is a Hamming window; or, w1[i] is a Hamming window and w2[i] is a sine window.

In an instance, if the coding mode is A-law or mu-law, when the frame length N=80,

$$w 1 [ i ] = \{ \begin{matrix}0.16 + 0.84 \cdot cos ( 2 \cdot π \cdot ( 31 - 4 \cdot i ) / 127 ) , & i = 0 , 1 , … , 7 \\ 1 , & i = 8 , 9 , … , 71 \\ 0.16 + 0.84 \cdot cos ( 2 \cdot π \cdot ( 4 \cdot i - 285 ) / 127 ) , & i = 72 , 73 , … , 79\end{matrix} \\ w 2 [ i ] = \{ \begin{matrix}0.26 + 0.74 \cdot cos ( 2 \cdot π \cdot ( 31 - 4 \cdot i ) / 127 ) , & i = 0 , 1 , … , 7 \\ 1 , & i = 8 , 9 , … , 71 \\ 0.26 + 0.74 \cdot cos ( 2 \cdot π \cdot ( 4 \cdot i - 285 ) / 127 ) , & i = 72 , 73 , … , 79.\end{matrix}$$

When the frame length N=40,

$$w 1 [ i ] = \{ \begin{matrix}0.28 + 0.72 \cdot cos ( 2 \cdot π \cdot ( 31 - 8 \cdot i ) / 127 ) , & i = 0 , 1 , … , 3 \\ 1 , & i = 4 , 5 , … , 35 \\ 0.28 + 0.72 \cdot cos ( 2 \cdot π \cdot ( 8 \cdot i - 281 ) / 127 ) , & i = 36 , 37 , … , 39\end{matrix} \\ w 1 [ i ] = \{ \begin{matrix}0.22 + 0.78 \cdot cos ( 2 \cdot π \cdot ( 31 - 8 \cdot i ) / 127 ) , & i = 0 , 1 , … , 3 \\ 1 , & i = 4 , 5 , … , 35 \\ 0.22 + 0.78 \cdot cos ( 2 \cdot π \cdot ( 8 \cdot i - 281 ) / 127 ) , & i - 36 , 37 , … , 39.\end{matrix}$$

S803. Process the windowed signals to obtain an LPC coefficient for linear prediction.

Through the LPC analysis method provided in the seventh embodiment, the coding mode of the input signals is obtained, the input signals are converted into PCM signals, and the input signals are windowed adaptively according to the coding mode. In this way, the prediction performance of LPC is improved with little increased complexity of coding.

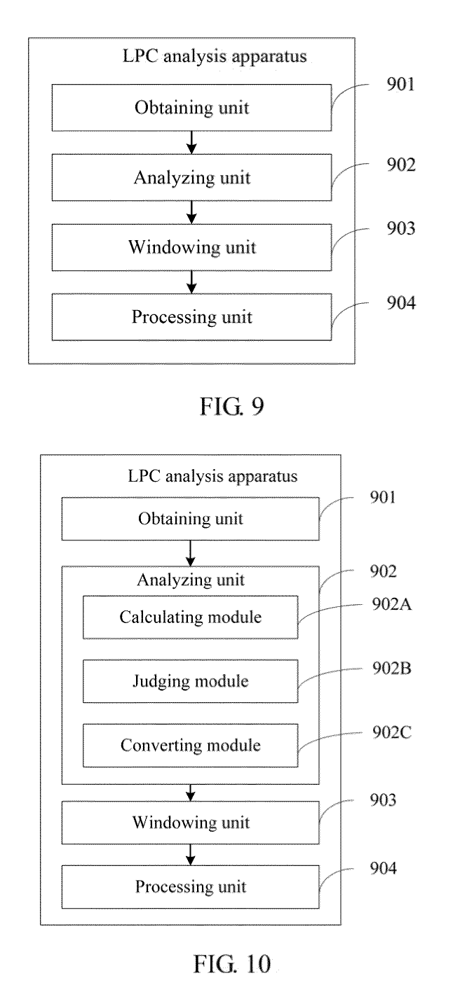

An LPC analysis apparatus is provided in an embodiment of the present invention. As shown in FIG. 9, the apparatus includes:

an obtaining unit 901, configured to obtain signal feature information of at least one sample point of input signals;

an analyzing unit 902, configured to compare and analyze the signal feature information to obtain an analysis result;

a windowing unit 903, configured to select a window function according to the analysis result to perform adaptive windowing for the input signals and obtain windowed signals; and

a processing unit 904, configured to process the windowed signals to obtain an LPC coefficient for linear prediction.

Through the LPC analysis apparatus provided herein, the input signals are analyzed to obtain an analysis result, and a window function required for windowing is allocated adaptively according to the analysis result. In this way, the prediction performance of LPC is improved with little increased complexity of coding.

As shown in FIG. 10, in another embodiment of the present invention, the analyzing unit 902 includes:

a calculating module 902A, configured to calculate a value of the signal feature information obtained by the obtaining unit 901, where the value of the signal feature information includes the value of signal feature information of a sample point and/or an average of values of signal feature information of multiple points; and

a judging module 902B, configured to judge whether the value of the signal feature information, calculated by the calculating module 902A, is greater than or equal to a threshold, or judge the signal type and/or coding mode of the input signals obtained by the obtaining unit 901.

Further, the analyzing unit 902 mentioned above includes:

a converting module 902C, configured to convert the input signals obtained by the obtaining unit 901 into PCM signals.

Through the LPC analysis apparatus provided herein, the input signals are analyzed to obtain an analysis result, and a window function required for windowing is allocated adaptively according to the analysis result. In this way, the prediction performance of LPC is improved with little increased complexity of coding.

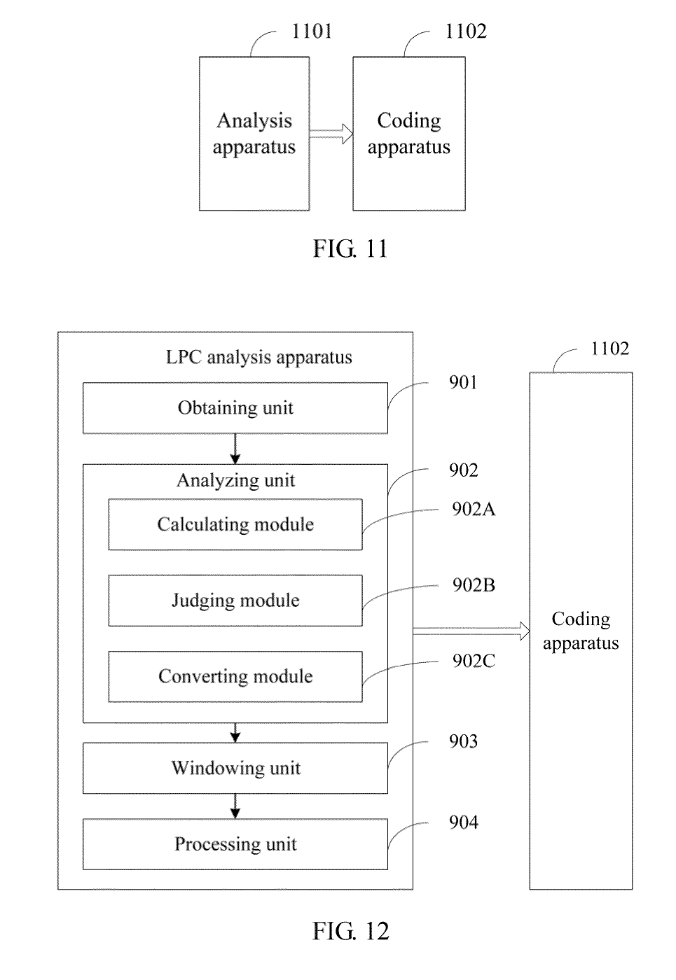

An LPC system is provided in an embodiment of the present invention. As shown in FIG. 11, the system includes:

an LPC analysis apparatus 1101, configured to: obtain signal feature information of at least one sample point of input signals; compare and analyze the signal feature information to obtain an analysis result; select a window function according to the analysis result to perform adaptive windowing for the input signals, and obtain windowed signals; and process the windowed signals to obtain an LPC coefficient; and

a coding apparatus 1102, configured to perform coding according to the LPC coefficient obtained by the LPC analysis apparatus 1101.

Through the LPC system provided herein, the input signals are analyzed to obtain an analysis result, and a window function required for windowing is allocated adaptively according to the analysis result to obtain an LPC coefficient, and then coding is performed according to the LPC coefficient. In this way, the prediction performance of LPC is improved with little increased complexity of coding.

As shown in FIG. 12, the LPC analysis apparatus 1101 in another embodiment of the present invention has the same structure as the LPC analysis apparatus in the above mentioned embodiment, and is not described in detail herein any further.

Through the LPC system provided herein, the input signals are analyzed to obtain an analysis result, and a window function required for windowing is allocated adaptively according to the analysis result to obtain an LPC coefficient, and then coding is performed according to the LPC coefficient. In this way, the prediction performance of LPC is improved with little increased complexity of coding.

Persons of ordinary skill in the art should understand that all or part of the steps of the method provided in the embodiments mentioned above may be implemented by a program instructing relevant hardware. The program may be stored in computer readable storage media. When the program runs, it may execute the steps of the method specified in any embodiment mentioned above. The storage media may be a magnetic disk, CD-ROM, Read-Only Memory (ROM), or Random Access Memory (RAM).

The above descriptions are merely exemplary embodiments of the present invention, but not intended to limit the scope of the present invention. Any modifications, variations or replacement that can be easily derived by those skilled in the art shall fall within the scope of the present invention. Therefore, the protection scope of the present invention is subject to the appended claims.

What is claimed is:

1. A Linear Prediction Coding (LPC) analysis method, comprising:
obtaining signal feature information of at least one sample point of input signals;
comparing and analyzing the signal feature information to obtain an analysis result;
selecting a window function, according to the analysis result, to perform adaptive windowing for the input signals and obtain windowed signals; and
processing the windowed signals to obtain an LPC coefficient for linear prediction.

2. The LPC analysis method according to claim 1, wherein the signal feature information comprises:
any one or any combination of amplitude, energy, zero-crossing rate, frame length;
the comparing and the analyzing the signal feature information to obtain an analysis result comprises:
calculating a value of the signal feature information and judging whether the value of the signal feature information is greater than or equal to a threshold, wherein the value of the signal feature information is the value of signal feature information of one or more specific sample points and/or an average of values of signal feature information of multiple points.

3. The LPC analysis method according to claim 2, wherein the signal feature information comprises: any one or both of type of the input signals, or coding mode of the input signals;
the comparing and the analyzing the signal feature information to obtain an analysis result comprises:
judging type and/or coding mode of the input signals.

4. The LPC analysis method according to claim 2, wherein the selecting a window function according to the analysis result to perform adaptive windowing for the input signals and obtain windowed signals comprises:
if it is determined that the value of the signal feature information is greater than or equal to a threshold, performing adaptive windowing for the input signals by using a first window function, and obtaining windowed signals; otherwise, performing adaptive windowing for the input signals by using a second window function, and obtaining windowed signals.

5. The LPC analysis method according to claim 2, wherein obtaining signal feature information of at least one sample point of input signals comprises:
obtaining an amplitude value of a first sample point of input signals; or
obtaining an average amplitude value of the first or last M sample points, M is a positive integer; or
obtaining an zero-crossing rate of the input signals;

6. The LPC analysis method according to claim 3, wherein: the selecting a window function according to the analysis result to perform adaptive windowing for the input signals and obtain windowed signals comprises:
if the type and/or the coding mode of the input signals is determined, selecting the first window function or the second window function according to the type and/or coding mode of the input signals to perform adaptive windowing for the input signals and obtain windowed signals.

7. The LPC analysis method according to claim 1, wherein the obtaining the signal feature information of at least one sample point of the input signals comprises:
converting the input signals into Pulse Coding Modulation (PCM) signals; and
obtaining the signal feature information of at least one sample point of the converted input signals.

8. A Linear Prediction Coding (LPC) analysis apparatus, comprising:
an obtaining unit, configured to obtain signal feature information of at least one sample point of input signals;
an analyzing unit, configured to compare and analyze the signal feature information to obtain an analysis result;
a windowing unit, configured to select a window function according to the analysis result to perform adaptive windowing for the input signals and obtain windowed signals; and
a processing unit, configured to process the windowed signals to obtain an LPC coefficient for linear prediction.

9. The LPC analysis apparatus according to claim 8, wherein the analyzing unit comprises:
a calculating module, configured to calculate a value of the signal feature information obtained by the obtaining unit, wherein the value of the signal feature information is the value of signal feature information of a specific sample point and/or an average of values of signal feature information of multiple points; and
a judging module, configured to judge whether the value of the signal feature information calculated by the calculating module is greater than or equal to a threshold, or judge signal type and/or coding mode of the input signals obtained by the obtaining unit.

10. The LPC analysis apparatus according to claim 9, wherein the analyzing unit further comprises:
a converting module, configured to convert the input signals obtained by the obtaining unit into Pulse Coding Modulation (PCM) signals.

11. The LPC analysis apparatus according to claim 9, wherein the windowing unit comprises:
a selecting module, configured to select a window function according to a result output by the judging module; and
a windowing module, configured to perform adaptive windowing for the input signals according to the window function selected by the selecting module to obtain windowed signals.

12. A Linear Prediction Coding (LPC) system, comprising:
an LPC analysis apparatus, configured to: obtain signal feature information of at least one sample point of input signals; compare and analyze the signal feature information to obtain an analysis result; select a window function according to the analysis result to perform adaptive windowing for the input signals and obtain windowed signals; and process the windowed signals to obtain an LPC coefficient; and
a coding apparatus, configured to perform coding according to the LPC coefficient obtained by the LPC analysis apparatus.

13. The LPC system according to claim 12, wherein the LPC analysis apparatus further comprises:
an obtaining unit, configured to obtain signal feature information of at least one sample point of input signals;
an analyzing unit, configured to compare and analyze the signal feature information to obtain an analysis result;
a windowing unit, configured to select a window function according to the analysis result to perform adaptive windowing for the input signals and obtain windowed signals; and
a processing unit, configured to process the windowed signals to obtain an LPC coefficient for linear prediction.

14. A computer readable storage medium, comprising computer program codes that cause the compute processor to execute the following steps when executed by a computer processor:
obtaining signal feature information of at least one sample point of input signals;
comparing and analyzing the signal feature information to obtain an analysis result;
selecting a window function, according to the analysis result, to perform adaptive windowing for the input signals and obtain windowed signals; and
processing the windowed signals to obtain an LPC coefficient for linear prediction.
